(19) United States
(12) Patent Application Publication
(10) Pub. No.: US 2022/0403983 A1
(43) Pub. Date: Dec. 22, 2022

(54) HYDROGEN FILLING SYSTEM AND HYDROGEN FILLING METHOD

(71) Applicant: TOYOTA JIDOSHA KABUSHIKI KAISHA, Toyota-shi (JP)

(72) Inventor: Akihito HAYASAKA, Miyoshi-shi (JP)

(73) Assignee: TOYOTA JIDOSHA KABUSHIKI KAISHA, Toyota-shi (JP)

(21) Appl. No.: 17/662,905

(22) Filed: May 11, 2022

(30) Foreign Application Priority Data
Jun. 18, 2021 (JP) 2021-101438

(51) Int. Cl. F17C 5/06

(52) U.S. Cl. CPC F17C 5/06; F17C 2221/012; F17C 2270/0139; F17C 2250/036; F17C 2250/0443; F17C 2250/0465; F17C 2250/0452

(57) ABSTRACT

A hydrogen filling system includes a hydrogen filling enable-disable determining device. The hydrogen filling enable-disable determining device is configured to acquire detection information detected by a vehicle and determine whether to enable or disable hydrogen filling to the vehicle at a hydrogen filling device provided in a hydrogen filling area of a hydrogen station, based on the detection information.

### CROSS-REFERENCE TO RELATED APPLICATION

This application claims priority to Japanese Patent Application No. 2021-101438 filed on Jun. 18, 2021, incorporated herein by reference in its entirety.

### BACKGROUND

### 1. Technical Field

The disclosure relates to a hydrogen filling system and a hydrogen filling method.

### 2. Description of Related Art

Japanese Unexamined Patent Application Publication No. 2017-003086 (JP 2017-003086 A) describes a self filling system in which a user fills up a hydrogen-fueled vehicle with hydrogen by him or herself with the use of a self filling machine in a hydrogen station. In this system, an image monitoring device, a calling device, and a filling enable-disable instruction device are provided. With the image monitoring device, an instructor is able to monitor a user around the self filling machine through an image in a monitoring facility for monitoring a hydrogen station remotely. The instructor and the user are able to talk to each other with the calling device. The filling enable-disable instruction device is capable of enabling or disabling filling work with the self filling machine based on operation of the instructor in the monitoring facility.

### SUMMARY

In JP 2017-003086 A, hydrogen filling is enabled or disabled based on information from equipment, such as a camera, installed in a hydrogen station. In other words, hydrogen filling is enabled or disabled depending on the equipment of a hydrogen station. For this reason, for example, determination as to whether to enable or disable hydrogen filling comes under the influence of whether the model of the equipment of a hydrogen station is new or old. In addition, equipment of a hydrogen station needs to be replaced, so hydrogen station-side cost increases.

The disclosure provides a hydrogen filling system and a hydrogen filling method capable of enabling or disabling hydrogen filling without dependence on equipment of a hydrogen station.

An aspect of the disclosure relates to a hydrogen filling system. The hydrogen filling system includes a hydrogen filling enable-disable determining device configured to acquire detection information detected by a vehicle and determine whether to enable or disable hydrogen filling to the vehicle at a hydrogen filling device provided in a hydrogen filling area of a hydrogen station, based on the detection information.

Another aspect of the disclosure relates to a hydrogen filling method. The hydrogen filling method includes acquiring detection information detected by a vehicle and determining whether to enable or disable hydrogen filling to the vehicle at a hydrogen filling device provided in a hydrogen filling area of a hydrogen station, based on the detection information.

According to the aspects of the disclosure, it is possible to provide a hydrogen filling system and a hydrogen filling method capable of enabling or disabling hydrogen filling without dependence on equipment of a hydrogen station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of a hydrogen filling system according to a first embodiment;

FIG. 2 is a block diagram showing the configuration of a vehicle according to the first embodiment;

FIG. 3 is a flowchart showing the operation of a hydrogen filling information center according to the first embodiment; FIG. 4 is a flowchart showing the operation of the hydrogen filling information center according to the first embodiment; and

FIG. 5 is a block diagram showing the configuration of a computer according to the present embodiment.

### DETAILED DESCRIPTION OF EMBODIMENTS

### First Embodiment

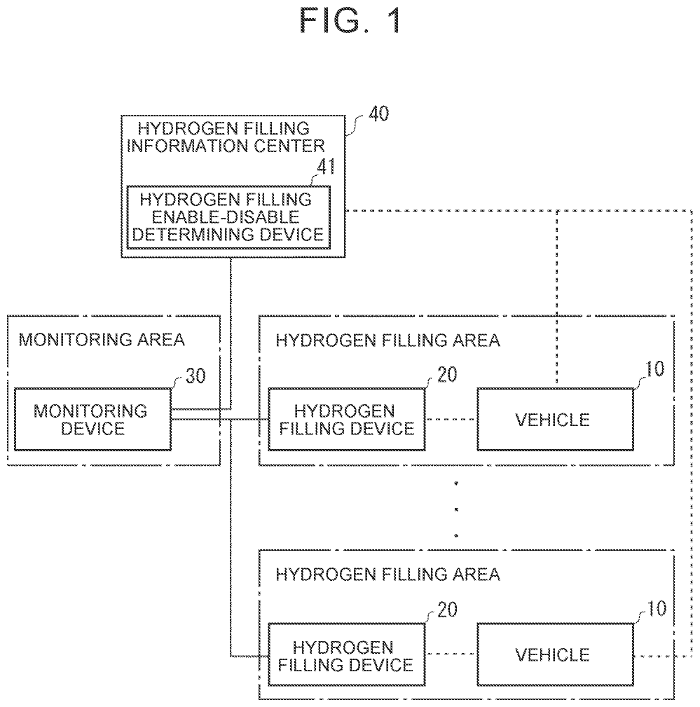

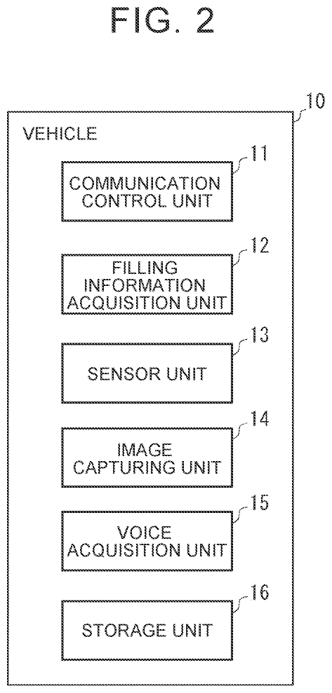

First, the configuration of a hydrogen filling system 1 according to a first embodiment will be described with reference to FIG. 1 and FIG. 2. The hydrogen filling system 1 includes vehicles 10, hydrogen filling devices 20, a monitoring device 30, and a hydrogen filling information center 40.

Each of the vehicles 10 is, for example, a fuel cell electric vehicle (FCEV) and runs by using hydrogen gas. The vehicle 10 includes a communication control unit 11, a filling information acquisition unit 12, a sensor unit (sensor) 13, an image capturing unit (image capturing device) 14, a voice acquisition unit (voice acquisition device) 15, and a storage unit 16. The communication control unit 11 communicates with the hydrogen filling devices 20 and the hydrogen filling information center 40 in a wireless communication system. The filling information acquisition unit 12 is mounted on the vehicle 10 and acquires filling information used between the vehicle 10 and the hydrogen filling device 20 in order to fill up the vehicle 10 with hydrogen gas. The filling information is, for example, information on the temperature, pressure, volume, filling level, or filling rate of a hydrogen tank.

The sensor unit 13 is a sensor mounted on the vehicle 10. The sensor unit 13 acquires, for example, sensor information on a hydrogen concentration, a hydrogen leakage sound, or a vibration in the vehicle 10. For example, the sensor unit 13 is installed at a hydrogen filling port of the hydrogen tank or an upper part of an FC stack in the vehicle 10. The image capturing unit 14 is a camera mounted on the vehicle 10. The image capturing unit 14 acquires a captured image of a user, for example, driving the vehicle 10, as capture image information. The capture image information may be a plurality of captured images obtained by capturing the image of the user of the vehicle 10 or may be a video obtained by filming the user of the vehicle 10. The voice acquisition unit 15 is a microphone mounted on the vehicle 10. The voice acquisition unit 15 acquires user's voice as voice information. The storage unit 16 stores, for example, vehicle information, such as registration information and hydrogen filling history of the vehicle 10.

The communication control unit 11 transmits the filling information acquired by the filling information acquisition unit 12, the sensor information acquired by the sensor unit 13, the capture image information acquired by the image capturing unit 14, and the voice information acquired by the voice acquisition unit 15, and the vehicle information stored in the storage unit 16 to the hydrogen filling information center 40. Here, the filling information, the sensor information, the capture image information, and the voice information are referred to as detection information that is information detected by the vehicle 10. The detection information is, more specifically, hydrogen filling environment information that is information on an environment in which hydrogen is filled in the vehicle 10.

The hydrogen filling device 20 is provided in a hydrogen filling area of a hydrogen station and communicates with the monitoring device 30 in a wireless communication system or a wired communication system. The hydrogen filling device 20 has a function to allow the user to be able to fill up the vehicle 10 with hydrogen by him or herself. Specifically, the hydrogen filling device 20 has a touch-screen ordering machine, and the user fills up the vehicle 10 with hydrogen in accordance with screen display and voice guidance. The hydrogen filling device 20 is controlled by the monitoring device 30 as to whether to enable or disable hydrogen filling to the vehicle 10.

The monitoring device 30 is installed in a monitoring area remote from the hydrogen filling areas in the hydrogen station and communicates with the hydrogen filling information center 40 and the hydrogen filling devices 20 installed respectively in the hydrogen filling areas in a wireless communication system or a wired communication system. The monitoring device 30 controls whether to enable or disable hydrogen filling to the vehicle 10 at the hydrogen filling device 20 in accordance with an instruction from the hydrogen filling information center 40. In addition, the monitoring device 30 controls whether to enable or disable hydrogen filling to the vehicle 10 at the hydrogen filling device 20 in accordance with an instruction of an instructor who is stationed in the monitoring area and monitors the hydrogen station. The monitoring device 30 may centrally manage a plurality of hydrogen stations and control the hydrogen filling devices 20 or may be installed in each hydrogen station and control the hydrogen filling devices 20.

The hydrogen filling information center 40 communicates with the vehicles 10 in a wireless communication system. The hydrogen filling information center 40 communicates with the monitoring device 30 in a wireless communication system or a wired communication system. Here, the hydrogen filling information center 40 is capable of communicating with a plurality of the vehicles 10 or a plurality of the monitoring devices 30 and performing integrated management of the vehicles 10 or the monitoring devices 30.

The hydrogen filling information center 40 includes a hydrogen filling enable-disable determining device 41. The hydrogen filling enable-disable determining device 41 acquires the vehicle information acquired from the vehicle 10 and determines whether to enable or disable the procedure of the user to start hydrogen filling to the vehicle 10 at the hydrogen filling device 20 based on the vehicle information. The hydrogen filling enable-disable determining device 41 acquires the detection information (filling information, sensor information, capture image information, and voice information) detected by the vehicle 10 and determines whether to enable or disable hydrogen filling to the vehicle 10 at the hydrogen filling device 20, based on the detection information. Then, the hydrogen filling enable-disable determining device 41 transmits an instruction based on the determination result to the monitoring device 30. The hydrogen filling information center 40 stores the vehicle information, filling information, sensor information, capture image information, and voice information acquired from each vehicle 10 in association with the vehicle 10.

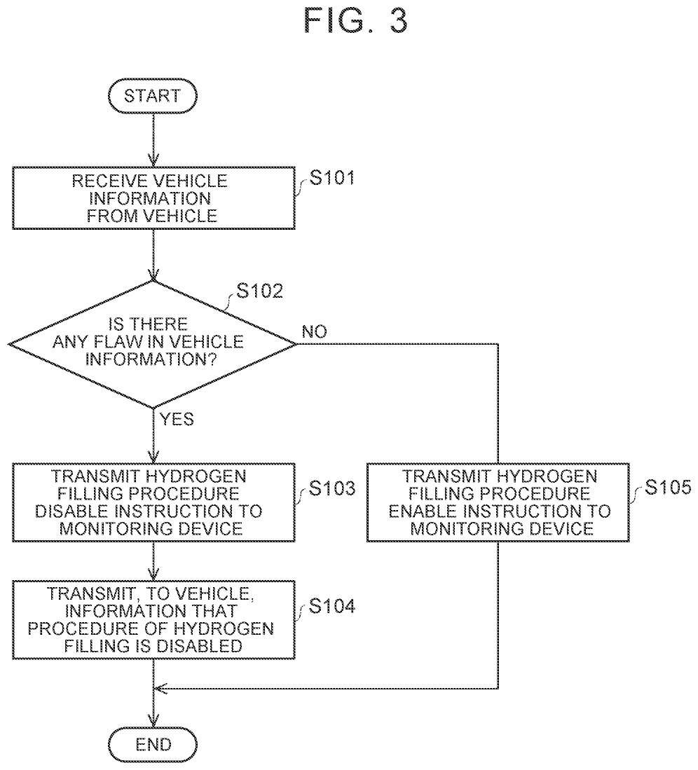

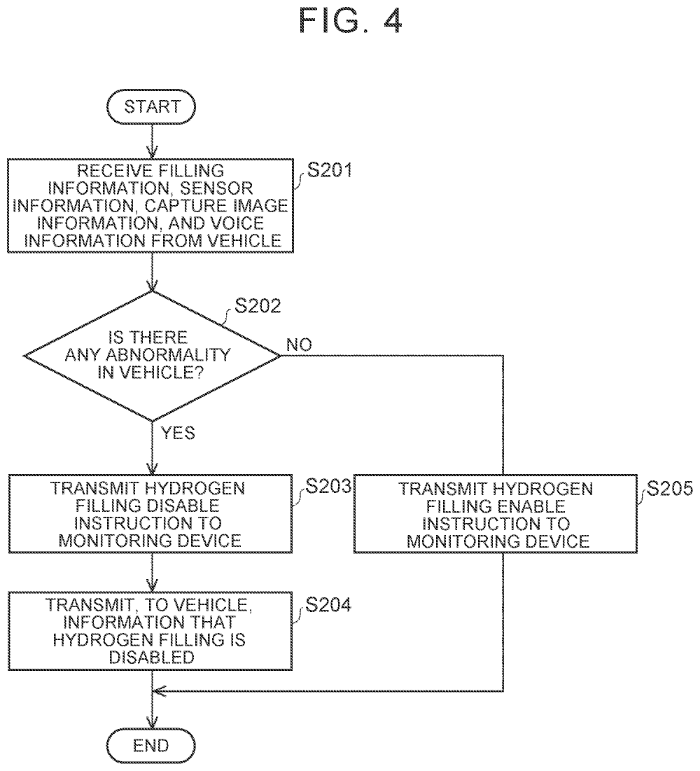

Subsequently, the operation of the hydrogen filling system 1 according to the first embodiment will be described. Hereinafter, the operation of the hydrogen filling information center 40 of the hydrogen filling system 1 will be described in detail with reference to FIG. 3 and FIG. 4. Initially, after the vehicle 10 arrives at the hydrogen filling area of the hydrogen station, the communication control unit 11 of the vehicle 10 acquires vehicle information from the storage unit 16. The vehicle information includes, for example, the vehicle registration information for identifying the vehicle 10 and the hydrogen filling history, such as the number of times hydrogen filling to the vehicle 10 has been performed in the past and a date and time at which hydrogen filling is performed. Then, the communication control unit 11 transmits the vehicle information to the hydrogen filling information center 40. The communication control unit 11 transmits identification information for identifying the hydrogen filling area to the hydrogen filling information center 40.

Next, as shown in FIG. 3, the hydrogen filling enable-disable determining device 41 of the hydrogen filling information center 40 receives the vehicle information from the vehicle 10 (step S101). Subsequently, the hydrogen filling enable-disable determining device 41 determines whether there is any flaw in the received vehicle information (step S102). For example, the hydrogen filling enable-disable determining device 41 determines that there is a flaw in the vehicle information when the vehicle 10 is not a registered vehicle from the vehicle registration information.

When there is a flaw in the vehicle information (YES in step S102), the hydrogen filling enable-disable determining device 41 transmits, to the monitoring device 30, an instruction to disable the procedure of the user to perform hydrogen filling to the vehicle 10 (hydrogen filling procedure disable instruction) (step S103). Here, the hydrogen filling enable-disable determining device 41 selects the monitoring device 30 provided in the monitoring area for monitoring the hydrogen filling area at which the vehicle 10 has arrived, by using the identification information for identifying the hydrogen filling area, acquired from the vehicle 10.

When the monitoring device 30 receives the hydrogen filling procedure disable instruction from the hydrogen filling enable-disable determining device 41, the monitoring device 30 causes the hydrogen filling device 20 to disable the procedure of the user to perform hydrogen filling to the vehicle 10. At this time, the monitoring device 30 may cause the hydrogen filling device 20 to disable the procedure of the user to perform hydrogen filling to the vehicle 10 in accordance with determination made by an instructor present in the monitoring area for which the hydrogen filling procedure disable instruction has been found. Subsequently, the hydrogen filling enable-disable determining device 41 transmits, to the vehicle 10, information that the procedure of the user to perform hydrogen filling to the vehicle 10 is disabled (step S104).

On the other hand, when there is no flaw in the vehicle information (NO in step S102), the hydrogen filling enable-disable determining device 41 transmits, to the monitoring device 30, an instruction to enable the procedure of the user to perform hydrogen filling to the vehicle 10 (hydrogen filling procedure enable instruction) (step S105). Here, the hydrogen filling enable-disable determining device 41 selects the monitoring device 30 provided in the monitoring area for monitoring the hydrogen filling area at which the vehicle 10 has arrived, by using the identification information for identifying the hydrogen filling area, acquired from the vehicle 10.

When the monitoring device 30 receives the hydrogen filling procedure enable instruction from the hydrogen filling enable-disable determining device 41, the monitoring device 30 causes the hydrogen filling device 20 to enable the procedure of the user to perform hydrogen filling to the vehicle 10. At this time, the monitoring device 30 may cause the hydrogen filling device 20 to enable the procedure of the user to perform hydrogen filling to the vehicle 10 in accordance with determination made by the instructor present in the monitoring area for which the hydrogen filling procedure enable instruction is found.

In step S101, after the vehicle 10 arrives at the hydrogen filling area, the vehicle 10 may transmit the vehicle information to the monitoring device 30 via the hydrogen filling device 20 or the hydrogen filling information center 40. In this case, the monitoring device 30 may determine whether there is any flaw in the vehicle information in accordance with an instruction of the instructor present in the monitoring area. Then, the monitoring device 30 may execute control as to whether to enable or disable hydrogen filling to the vehicle 10 at the hydrogen filling device 20 in accordance with the determination result.

Subsequently, after step S105, when the hydrogen filling device 20 enables the procedure of the user to perform hydrogen filling to the vehicle 10, the user performs a predetermined procedure to start hydrogen filling by him or herself at the hydrogen filling device 20 in the hydrogen filling area. The predetermined procedure is, for example, a procedure by which the user performs operation, such as entering private information and using a credit card, in accordance with screen display, voice guidance, or the like on a display of the hydrogen filling device 20. Then, after the user completes the predetermined procedure to start hydrogen filling, the hydrogen filling device 20 transmits, to the vehicle 10, an instruction to start hydrogen filling.

Subsequently, after receiving the instruction to start hydrogen filling from the hydrogen filling device 20, the filling information acquisition unit 12 of the vehicle 10 acquires filling information, such as the temperature, pressure, volume, filling level, and filling rate of the hydrogen tank, used between the vehicle 10 and the hydrogen filling device 20 in order to fill up the vehicle 10 with hydrogen gas. The sensor unit 13 acquires sensor information, such as a hydrogen concentration, a hydrogen leakage sound, and a vibration, in the vehicle 10. The image capturing unit 14 acquires a captured image of the user, for example, driving the vehicle 10, as capture image information. The voice acquisition unit 15 acquires the voice of the user of the vehicle 10 as voice information. The communication control unit 11 transmits the filling information acquired by the filling information acquisition unit 12, the sensor information acquired by the sensor unit 13, the capture image information acquired by the image capturing unit 14, and the voice information acquired by the voice acquisition unit 15 to the hydrogen filling information center 40. At this time, the communication control unit 11 may transmit any one or more of the filling information, the sensor information, the capture image information, and the voice information to the hydrogen filling information center 40.

The storage unit 16 of the vehicle 10 may prestore the filling information acquired by the filling information acquisition unit 12, the sensor information acquired by the sensor unit 13, the capture image information acquired by the image capturing unit 14, and the voice information acquired by the voice acquisition unit 15. In this case, the communication control unit 11 may acquire the filling information, the sensor information, the capture image information, and the voice information from the storage unit 16 and transmit the acquired filling information, sensor information, capture image information, and voice information to the hydrogen filling information center 40.

Next, as shown in FIG. 4, the hydrogen filling enable-disable determining device 41 of the hydrogen filling information center 40 receives the filling information, the sensor information, the capture image information, and the voice information from the vehicle 10 (step S201). The hydrogen filling enable-disable determining device 41 determines whether there is any abnormality in the vehicle 10 by using the received filling information, sensor information, capture image information, and voice information (step S202). Specifically, the hydrogen filling enable-disable determining device 41 determines whether there is any abnormality in the vehicle 10, such as an abnormal hydrogen concentration, an abnormal hydrogen leakage sound, and an abnormal vibration, in the vehicle 10 by using the sensor information. The hydrogen filling enable-disable determining device 41 determines whether there is an abnormal behavior of the user of the vehicle 10, such as a dangerous behavior and accidental behavior of the user of the vehicle 10, by using the capture image information or the voice information. The hydrogen filling enable-disable determining device 41 automatically determines whether there is an abnormality in the vehicle 10 by using the filling information, the sensor information, the capture image information, and the voice information through, for example, machine learning or the like.

When there is an abnormality in the vehicle 10 (YES in step S202), the hydrogen filling enable-disable determining device 41 transmits, to the monitoring device 30, a hydrogen filling disable instruction to disable hydrogen filling to the vehicle 10 (step S203). When the monitoring device 30 receives the hydrogen filling disable instruction from the hydrogen filling enable-disable determining device 41, the monitoring device 30 causes the hydrogen filling device 20 to disable hydrogen filling to the vehicle 10. At this time, the monitoring device 30 may cause the hydrogen filling device 20 to disable hydrogen filling to the vehicle 10 in accordance with determination of the instructor present in the monitoring area for which the hydrogen filling disable instruction is found. Subsequently, the hydrogen filling enable-disable determining device 41 transmits, to the vehicle 10, information that hydrogen filling to the vehicle 10 is disabled (step S204).

On the other hand, when the hydrogen filling enable-disable determining device 41 determines that there is no abnormality in the vehicle 10 (NO in step S202), the hydrogen filling enable-disable determining device 41 transmits, to the monitoring device 30, a hydrogen filling enable instruction to enable hydrogen filling to the vehicle 10 (step S205). When the monitoring device 30 receives the hydrogen filling enable instruction from the hydrogen filling enable-disable determining device 41, the monitoring device 30 causes the hydrogen filling device 20 to enable hydrogen filling to the vehicle 10. At this time, the monitoring device 30 may cause the hydrogen filling device 20 to enable hydrogen filling to the vehicle 10 in accordance with determination of the instructor present in the monitoring area for which the hydrogen filling enable instruction is found. As a result, the user of the vehicle 10 is able to start hydrogen filling to the vehicle 10 at the hydrogen filling device 20.

Subsequently, when the hydrogen filling device 20 enables hydrogen filling to the vehicle 10, the user starts hydrogen filling to the vehicle 10 at the hydrogen filling device 20. While hydrogen filling to the vehicle 10 is being performed at the hydrogen filling device 20, the hydrogen filling enable-disable determining device 41 repeats the process of step S201, step S202, step S203, and step S204.

In step S201, the vehicle 10 may transmit the filling information, the sensor information, the capture image information, and the voice information to the monitoring device 30 via the hydrogen filling device 20 or the hydrogen filling information center 40. In this case, the instructor in the monitoring area may determine whether there is any abnormality in the vehicle 10 based on the received various pieces of information. Then, the monitoring device 30 may execute control as to whether to enable or disable hydrogen filling to the vehicle 10 at the hydrogen filling device 20 in accordance with the determination result.

The hydrogen filling enable-disable determining device 41 and the instructor present in the monitoring area may cooperatively determine whether there is any abnormality in the vehicle 10 by using the filling information, the sensor information, the capture image information, and the voice information. When, for example, the instructor present in the monitoring area finds a determination result that the hydrogen filling enable-disable determining device 41 determines that there is an abnormality in the vehicle 10 and approves the determination result, the monitoring device 30 may cause the hydrogen filling device 20 to disable hydrogen filling to the vehicle 10.

Subsequently, after completion of hydrogen filling, the hydrogen filling information center 40 stores all the pieces of information (that is, the filling information, the sensor information, the capture image information, the voice information, and the vehicle information) transmitted from the vehicle 10 to the hydrogen filling information center 40 and the monitoring device 30. Thus, the hydrogen filling information center 40 uses the pieces of information at the time of hydrogen filling to the vehicle 10 next time and later.

Therefore, in the hydrogen filling system 1 according to the first embodiment, the hydrogen filling information center 40 determines whether to enable or disable hydrogen filling to the vehicle 10 at the hydrogen filling device 20 based on the detection information detected by the vehicle 10. Therefore, the hydrogen filling system 1 is capable of enabling or disabling hydrogen filling to the vehicle 10 without dependence on equipment of a hydrogen station. Thus, the hydrogen filling system 1 determines whether to enable or disable hydrogen filling to the vehicle 10 without the influence of whether the model of the equipment of the hydrogen station is new or old. In addition, the hydrogen filling system 1 does not need to replace equipment of a hydrogen station, so an increase in hydrogen station-side cost is suppressed.

In the hydrogen filling system 1, the hydrogen filling information center 40 acquires not only the filling information from the filling information acquisition unit 12 but also the sensor information acquired by the sensor unit 13, the capture image information acquired by the image capturing unit 14, and the voice information acquired by the voice acquisition unit 15. Then, the hydrogen filling information center 40 determines whether to enable or disable hydrogen filling to the vehicle 10 at the hydrogen filling device 20 based on the acquired pieces of information. Therefore, the hydrogen filling system 1 is able to handle cases where evolution of fuel cell electric vehicles, such as improvement in filling function, and extensive proliferation of a wide variety of fuel cell electric vehicles by improving the accuracy of determining whether to enable or disable hydrogen filling based on sensor information, capture image information, and voice information.

In the hydrogen filling system 1, the hydrogen filling information center 40 acquires information from the vehicles 10 and automatically determines whether to enable or disable hydrogen filling to the vehicles 10 respectively at the hydrogen filling devices 20. In other words, the hydrogen filling system 1 implements automation and efficiency of monitoring hydrogen filling to each of the vehicles 10. Therefore, the hydrogen filling system 1 improves the convenience of customers in a hydrogen station by extending the operation time of the hydrogen station and reduces a burden on instructors in monitoring areas. Thus, the hydrogen filling system 1 is able to promote and accelerate proliferation of fuel cell electric vehicles and hydrogen stations.

In the hydrogen filling system 1, the hydrogen filling information center 40 performs integrated management of the monitoring devices 30 that respectively monitor hydrogen stations. Therefore, even when hydrogen stations are operated by different groups, it is possible to implement information sharing between the hydrogen stations.

The disclosure is not limited to the above-described embodiment and may be modified as needed without departing from the scope of the disclosure.

### Hardware Configuration

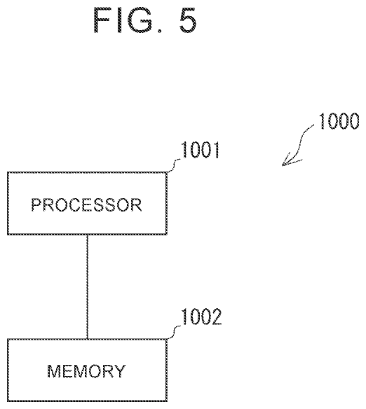

Next, an example of the hardware configuration of a computer 1000 of each of the components concerned with the hydrogen filling system 1 will be described with reference to FIG. 5. As shown in FIG. 5, the computer 1000 includes a processor 1001 and a memory 1002. The processor 1001 may be, for example, a microprocessor, a microprocessing unit (MPU), or a central processing unit (CPU). The processor 1001 may include a plurality of processors. The memory 1002 is made up of a combination of a volatile memory and a nonvolatile memory. The memory 1002 may include a storage placed remote from the processor 1001. In this case, the processor 1001 may access the memory 1002 via an I/O interface (not shown).

Each of the components in the above-described embodiment is made up of hardware or software or both, may be made up of one piece of hardware or one piece of software, or may be made up of a plurality of pieces of hardware or a plurality of pieces of software. The functions (processes) of the components in the above-described embodiment may be implemented by a computer. For example, programs for performing a method according to the embodiment may be stored in the memory 1002, and the functions may be implemented by the processor 1001 running the programs stored in the memory 1002.

Each of the programs includes a command set (or software code) for causing a computer to execute one or more functions described in the embodiment when the program is loaded onto the computer. The programs may be stored in a non-transitory computer-readable medium or tangible storage medium. Nonrestrictive examples of the computer-readable medium or tangible storage medium include memory technologies, such as a random-access memory (RAM), a read-only memory (ROM), a flash memory, a solid-state drive (SSD), and others, optical disk storages, such as a CD-ROM, a digital versatile disc (DVD), a Blu-ray (registered trademark) disc, and others, and magnetic storage devices, such as a magnetic cassette, a magnetic tape, a magnetic disk storage, and others. The programs may be transmitted on a transitory computer-readable medium or communication medium. Nonrestrictive examples of the temporary computer-readable medium or communication medium include an electrical, optical, acoustic, or other-type propagation signals.

What is claimed is:

1. A hydrogen filling system comprising a hydrogen filling enable-disable determining device configured to acquire detection information detected by a vehicle and determine whether to enable or disable hydrogen filling to the vehicle at a hydrogen filling device provided in a hydrogen filling area of a hydrogen station, based on the detection information.

2. The hydrogen filling system according to claim 1, further comprising a hydrogen filling information center configured to communicate with a plurality of vehicles and provided with the hydrogen filling enable-disable determining device.

3. The hydrogen filling system according to claim 1, wherein:
the hydrogen filling enable-disable determining device is configured to acquire, from the vehicle, identification information for identifying the hydrogen filling area in which the hydrogen filling device is provided; and
the hydrogen filling enable-disable determining device is configured to transmit a determination result as to whether to enable or disable hydrogen filling to the vehicle at the hydrogen filling device, to a monitoring device provided in a monitoring area for monitoring the hydrogen filling area.

4. The hydrogen filling system according to claim 3, wherein the hydrogen filling enable-disable determining device is configured to cause the monitoring device to execute control as to whether to enable or disable hydrogen filling to the vehicle at the hydrogen filling device based on a determination result as to whether to enable or disable hydrogen filling to the vehicle at the hydrogen filling device.

5. The hydrogen filling system according to claim 1, wherein:
the hydrogen filling enable-disable determining device is configured to acquire detection information detected by the vehicle;
the hydrogen filling enable-disable determining device is configured to determine whether there is any abnormality in the vehicle based on the detection information; and
the hydrogen filling enable-disable determining device is configured to disable hydrogen filling to the vehicle at the hydrogen filling device when the hydrogen filling enable-disable determining device determines that there is an abnormality in the vehicle.

6. The hydrogen filling system according to claim 5, wherein:
the hydrogen filling enable-disable determining device is configured to acquire sensor information detected by a sensor mounted on the vehicle;
the hydrogen filling enable-disable determining device is configured to determine whether there is any abnormality in the vehicle based on the sensor information; and
the hydrogen filling enable-disable determining device is configured to disable hydrogen filling to the vehicle at the hydrogen filling device when the hydrogen filling enable-disable determining device determines that there is an abnormality in the vehicle.

7. The hydrogen filling system according to claim 6, wherein the sensor information is any one or more of a hydrogen concentration in the vehicle, a hydrogen leakage sound in the vehicle, and a vibration in the vehicle.

8. The hydrogen filling system according to claim 5, wherein:
the hydrogen filling enable-disable determining device is configured to acquire capture image information captured by an image capturing device mounted on the vehicle;
the hydrogen filling enable-disable determining device is configured to determine whether there is any abnormal behavior of a user of the vehicle based on the capture image information; and
the hydrogen filling enable-disable determining device is configured to disable hydrogen filling to the vehicle at the hydrogen filling device when there is an abnormal behavior of the user of the vehicle.

9. The hydrogen filling system according to claim 5, wherein:
the hydrogen filling enable-disable determining device is configured to acquire voice information acquired by a voice acquisition device mounted on the vehicle;
the hydrogen filling enable-disable determining device is configured to determine whether there is any abnormal behavior of a user of the vehicle based on the voice information; and
the hydrogen filling enable-disable determining device is configured to disable hydrogen filling to the vehicle at the hydrogen filling device when there is an abnormal behavior of the user of the vehicle.

10. A hydrogen filling method comprising acquiring detection information detected by a vehicle and determining whether to enable or disable hydrogen filling to the vehicle at a hydrogen filling device provided in a hydrogen filling area of a hydrogen station, based on the detection information.
